(19) United States
(12) Patent Application Publication
(10) Pub. No.: US 2026/0145599 A1
(43) Pub. Date: May 28, 2026

(54) SEATBACK AIR BLOWER ATTACHMENT STRUCTURE, AND VEHICLE SEAT

(71) Applicants: NHK SPRING CO., LTD., Yokohama-shi (JP); SUBARU CORPORATION, Tokyo (JP)

(72) Inventors: Kenzo YASUDA, Yokohama-shi (JP); Kazuhiro TOYOSHIMA, Yokohama-shi (JP); Masato FUKUSHIMA, Tokyo (JP); Yosuke ISHIYAMA, Tokyo (JP)

(21) Appl. No.: 19/330,079

(22) Filed: Sep. 16, 2025

(30) Foreign Application Priority Data
Sep. 18, 2024 (JP) 2024-161419

(51) Int. Cl. B60N 2/56; B60N 2/66; B60N 2/68

(52) U.S. Cl. CPC B60N 2/5657; B60N 2/66; B60N 2/68

(57) ABSTRACT

A seatback air blower attachment structure includes left/right lumbar wires, a lumbar support mechanism, an attachment bracket, an air blower, and an attachment wire. The left/right lumbar wires extend between upper and lower sections of a vehicle seat seatback frame. The lumbar support mechanism is attached to the left/right lumbar wires. The attachment bracket is arranged at a seat upper side of the lumbar support mechanism. The air blower is attached to a seat rear side face of the attachment bracket. The attachment wire includes left/right attachment sections that extend from an upper end portion of the lumbar support mechanism with left/right side portions of the attachment bracket attached thereto, and that deform in a case in which a load from a seat front side is imparted to the attachment bracket.

### CROSS-REFERENCE TO RELATED APPLICATION

This application is based on and claims priority under 35 USC 119 from Japanese Patent Application No. 2024-161419 filed on September 18, 2024, the disclosure of which is incorporated by reference herein.

### BACKGROUND

### Technical Field

The present disclosure relates to a vehicle seat, and in particular to an attachment structure to attach an air blower to a seatback.

### Related Art

In a vehicle seat disclosed in Japanese Patent No. 6766695, an air blower is attached through a plate (attachment bracket) to left and right wires (lumbar wires) that are attached to a back frame.

### SUMMARY

In the related art described above, locations on the left and right lumbar wires where the air blower attachment bracket is attached are bent to a substantially crank shaped profile, and because displacement of the air blower attachment bracket toward a seat rear side is suppressed by the lumbar wires, the back of a seated person does not readily sink into the seatback at a time of a vehicle rear-end collision. As a result thereof, there is room for improvement from the perspective of preventing whiplash injury to a seated person arising from a delay in timing until the head of the seated person is supported by a headrest.

An object of the present disclosure is to obtain a seatback air blower attachment structure that facilitates the back of a seated person sinking in to a seatback at a time of a vehicle rear-end collision, and to a vehicle seat of the same.

A seatback air blower attachment structure of a first aspect of the present disclosure includes left and right lumbar wires, a lumbar support mechanism, an attachment bracket, an air blower, and an attachment wire. The left and right lumbar wires respectively extend between an upper section and a lower section of a seatback frame of a vehicle seat. The lumbar support mechanism is attached to the left and right lumbar wires. The attachment bracket is arranged at a seat upper side with respect to the lumbar support mechanism. The air blower is attached to a seat rear side face of the attachment bracket. The attachment wire includes left and right attachment sections that extend from an upper end portion of the lumbar support mechanism with left and right side portions of the attachment bracket attached thereto, the left and right attachment sections deforming in a case in which a load from a seat front side is imparted to the attachment bracket.

In the first aspect, the left and right lumbar wires extend between the upper section and the lower section of the vehicle seat seatback frame, and the lumbar support mechanism is attached to the left and right lumbar wires. The attachment bracket is arranged at the seat upper side with respect to the lumbar support mechanism, and the air blower is attached to the seat rear side face of the attachment bracket. The left and right attachment sections of the attachment wire extend from the upper end portion of the lumbar support mechanism and left and right side portions of the attachment bracket are attached to the left and right attachment sections. The left and right attachment sections of the attachment wire deform in a case in which a load from the back of a seated person is imparted from a seat front side to the attachment bracket at a time of a vehicle rear-end collision. This thereby facilitates the back of the seated person sinking into the seatback.

A seatback air blower attachment structure of a second aspect is the first aspect, wherein the attachment sections each include a first vertical extension portion extending from an upper end portion of the lumbar support mechanism toward the seat upper side, a first horizontal extension portion extending from an upper end of the first vertical extension portion toward a seat left-right direction outer side, a second vertical extension portion extending from a seat left-right direction outer side end portion of the first horizontal extension portion toward a seat lower side, and a second horizontal extension portion that extends from a lower end of the second vertical extension portion toward a seat left-right direction inner side and that is connected to an upper end portion of the lumbar support mechanism. Herein, the side portions each include a first anchor claw anchored to the first vertical extension portion, and a second anchor claw anchored to the first horizontal extension portion.

In the second aspect, the first vertical extension portion of each of the left right attachment sections of the attachment wire extends from an upper end portion of the lumbar support mechanism toward the seat upper side, the first horizontal extension portion thereof extends from the upper end of the first vertical extension portion toward the seat left-right direction outer side, the second vertical extension portion thereof extends from the seat left-right direction outer side end portion of the first horizontal extension portion toward the seat lower side, and the second horizontal extension portion thereof extends from the lower end of the second vertical extension portion toward the seat left-right direction inner side and the second horizontal extension portion is connected to the upper end portion of the lumbar support mechanism. The first anchor claws provided to the side portions of the attachment bracket are anchored to the first vertical extension portions of the attachment section, and the second anchor claws provided to the side portions of the attachment bracket are anchored to the first horizontal extension portions of the attachment section. The attachment bracket is permitted to flex toward the seat rear side between the first vertical extension portions of the left and right attachment sections in a case in which a load from the seat front side is imparted to the attachment bracket. This thereby further facilitates the back of the seated person sinking into the seatback.

A seatback air blower attachment structure of a third aspect is the second aspect, wherein the attachment bracket resiliently deforms under a load from the back of a seated person at a time of normal usage.

In the third aspect, the attachment bracket resiliently deforms under a load from the back of a seated person at a time of normal usage. This thereby enables good seating comfort to be achieved for the seated person.

A seatback air blower attachment structure of a fourth aspect is the second aspect or the third aspect, wherein the attachment bracket plastically deforms under a load from the back of a seated person at a time of a vehicle rear-end collision.

In the fourth aspect, the attachment bracket plastically deforms under a load from the back of a seated person at a time of a vehicle rear-end collision. This thereby enables energy of the seated person to be absorbed, enabling the seated person whose back has sunk into the seatback to be suppressed from rebounding toward the seat front side.

A seatback air blower attachment structure of a fifth aspect is any one aspect of the first aspect to the fourth aspect, wherein the left and right attachment sections resiliently deform under a load from the back of a seated person at a time of normal usage.

In the fifth aspect, the left and right attachment sections of the attachment wire resiliently deform under a load from the back of a seated person at a time of normal usage. This thereby enables good seating comfort to be achieved for the seated person.

A seatback air blower attachment structure of a sixth aspect is any one aspect of the first aspect to the fifth aspect, wherein the left and right attachment sections plastically deform under a load from the back of a seated person at a time of a vehicle rear-end collision.

In the sixth aspect, the left and right attachment sections of the attachment wire plastically deform under a load from the back of a seated person at a time of a vehicle rear-end collision. This thereby enables energy of the seated person to be absorbed, enabling the seated person whose back has sunk into the seatback to be suppressed from rebounding toward the seat front side.

A vehicle seat of a seventh aspect includes a seat cushion at which a seated person sits, and a seatback configured to support the back of the seated person, wherein the seatback includes the seatback air blower attachment structure of any one aspect of the first aspect to the sixth aspect.

In a vehicle seat of the seventh aspect, the back of a seated person seated on a seat cushion is supported by the seatback. This seatback includes the seatback air blower attachment structure of any one aspect of the first aspect to the sixth aspect, and so the advantageous effect described above are exhibited thereby.

As described above, the present disclosure facilitates the back of a seated person sinking into a seatback at a time of a vehicle rear-end collision.

### BRIEF DESCRIPTION OF THE DRAWINGS

Exemplary embodiments of the present invention will be described in detail based on the following figures, wherein:

FIG. 1 is a side view illustrating a vehicle seat according to an exemplary embodiment;

FIG. 2 is a first perspective view illustrating part of a seatback of the same vehicle seat;

FIG. 3 is a second perspective view illustrating part of a seatback of the same vehicle seat;

FIG. 4 is a perspective view illustrating a lumbar wire, a lumbar support mechanism, an attachment bracket, an air blower, and an attachment wire;

FIG. 5 is a perspective view illustrating a lumbar wire, an attachment bracket, an air blower, and an attachment wire;

FIG. 6 is a perspective view illustrating an attachment bracket and an attachment wire;

FIG. 7 is a perspective view illustrating an attachment bracket;

FIG. 8 is a first perspective view illustrating an attachment wire;

FIG. 9 is a second perspective view illustrating an attachment wire; and

FIG. 10 is a perspective view for explaining a state in which a load from a seat front side is imparted to an attachment bracket.

### DETAILED DESCRIPTION

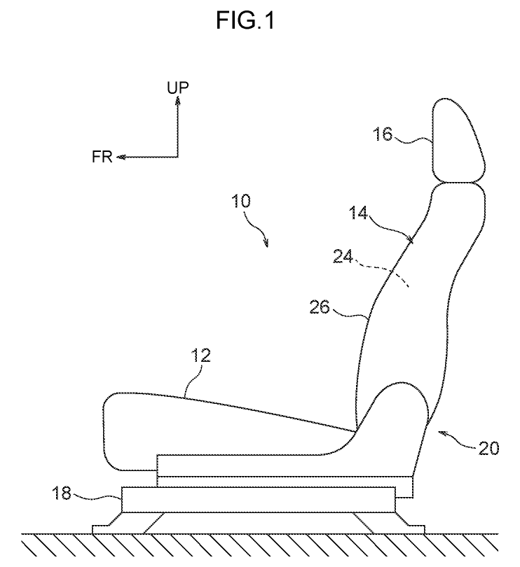

Description follows regarding a vehicle seat 10 according to an exemplary embodiment of the present disclosure, with reference to FIG. 1 to FIG. 10. Note that sometimes some of the reference numerals are omitted in the drawings in order to make the drawings easier to read. Moreover, as appropriate in the drawings, the arrows FR, LH, RH, and UP respectively indicate forward, leftward, rightward, and upward directions of the vehicle seat 10. Hereinafter, when reference is simply given to front and rear, left and right, up and down in the following description then this indicates directions with respect to the vehicle seat 10.

As illustrated in FIG. 1, the vehicle seat 10 according to the present exemplary embodiment is, for example, a vehicle front seat, and includes a seat cushion 12 for a seated person to sit on, a seatback 14 to support the back of the seated person, and a headrest 16 to support the head of the seated person. The seat cushion 12 is coupled to a floor section of a vehicle through a known slide mechanism 18. A lower end portion of the seatback 14 is coupled to a rear end portion of the seat cushion 12 through a known reclining mechanism 20. The headrest 16 is coupled to an upper end portion of the seatback 14 so as to be adjustable in height position.

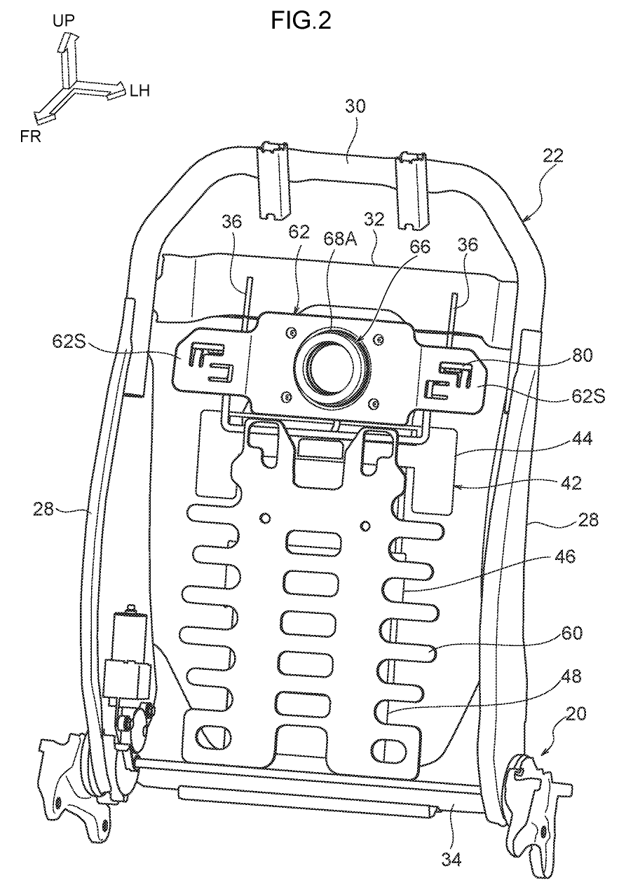

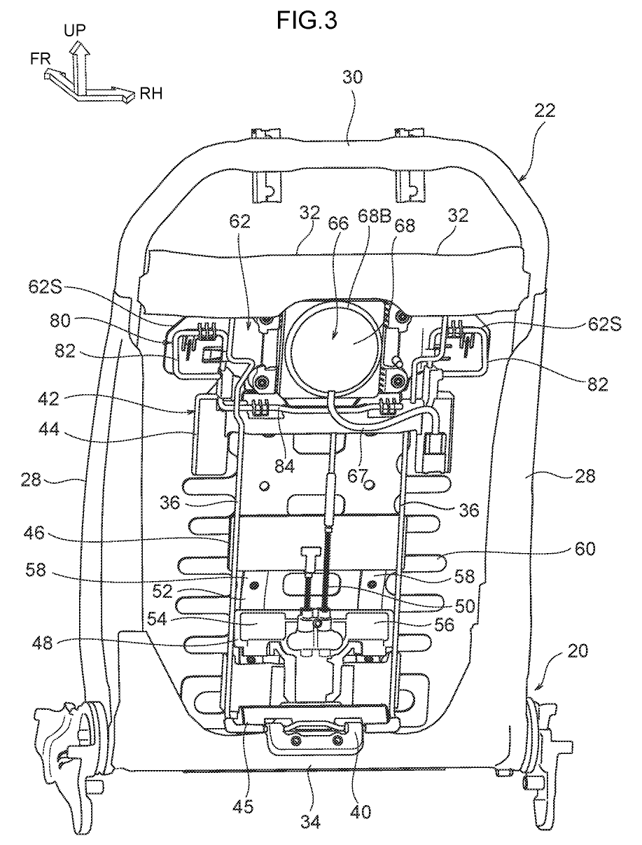

The seatback 14 includes a seatback frame 22 that is a framework member (see FIG. 2 and FIG. 3), a seatback pad 24 that is a cushion member (see FIG. 1), and a trim cover 26 that is a covering member (see FIG. 1). The seatback frame 22 includes a left-right pair of side frames 28, an upper frame 30 that connects upper end portions of the left and right side frames 28 together in the left-right direction, an upper bracket 32 attached to the upper frame 30, and a lower frame 34 that connects lower end portions of the left and right side frames 28 together in the left-right direction. The upper frame 30 and the upper bracket 32 are arranged in an upper section of the seatback 14, and the lower frame 34 is arranged in a lower section of the seatback 14.

The left and right side frames 28, the upper bracket 32, and the lower frame 34 are, for example, configured from metal plate blanks that have been press molded, and the upper frame 30 is, for example, configured from a metal pipe member that has been subjected to bend processing. The upper frame 30 is configured in a substantially inverted U-shape when viewed along the front-rear direction, and the upper bracket 32 extends across between left and right end portions of a lower section of the upper frame 30.

The seatback pad 24 is, for example, configured from a foam body of urethane foam or the like, and is covered over the seatback frame 22 from above. The trim cover 26 is, for example, formed in a bag shape by stitching together plural covering pieces of cloth material, leather, synthetic leather, or the like, and is covered over the seatback pad 24 from above.

Left and right lumbar wires 36 extend between the upper bracket 32 provided to the upper section of the seatback frame 22, and the lower frame 34 provided to the lower end portion of the seatback 14. The left and right lumbar wires 36 extend in the height direction, and are arranged spaced apart from each other in the left-right direction. Lower end portions of the left and right lumbar wires 36 are coupled together in the left-right direction by a coupling wire 38, with the coupling wire 38 fixed to the lower frame 34. The left and right lumbar wires 36 and the coupling wire 38 are, for example, configured from a single strand of metal wire material. Note that a fixing member 40 fastened and fixed to the lower frame 34 is attached to the coupling wire 38.

A lumbar support mechanism 42 is attached to the left and right lumbar wires 36. The lumbar support mechanism 42 includes an upper side base 44 disposed in the upper section of the seatback 14, an upper side variable height section 46 disposed at a height direction intermediate portion of the seatback 14, a lower side variable height section 48 disposed at lower section of the seatback 14, and a lower side base 45 disposed at a lower end portion of the seatback 14. The upper side base 44, the upper side variable height section 46, the lower side variable height section 48, and the lower side base 45 are, for example, each manufactured from injection molded resin, and are formed in substantially plate shapes having a length direction aligned with the left-right direction and a plate thickness direction aligned with the front-rear direction.

The upper side base 44 is, for example, integrally molded together with the left and right lumbar wires 36, with the left and right side portions of the upper side base 44 fixed to the left and right lumbar wires 36. Left and right end portions of the upper side variable height section 46 and the lower side variable height section 48 are engaged so as to be slidable in the height direction with respect to the left and right lumbar wires 36. The lower side base 45 is, for example, integrally molded together with the coupling wire 38, with the coupling wire 38 embedded in the lower side base 45. The upper side base 44, the upper side variable height section 46, the lower side variable height section 48, and the lower side base 45 are coupled together through a feed screw 50, and the upper side variable height section 46 and the lower side variable height section 48 are coupled together through a feed screw 52. The feed screws 50, 52 are arranged with their axial directions aligned with the height direction.

Two motors 54, 56 are attached to the lower side variable height section 48. The feed screws 50, 52 are able to be rotated individually by these motors 54, 56. When the feed screw 50 is rotated by the motor 56, the upper side variable height section 46 and the lower side variable height section 48 are together raised or lowered (moved so as to approach or separate) with respect to the upper side base 44 and the lower side base 45. When the feed screw 52 is rotated by the motor 54, the upper side variable height section 46 is raised or lowered (moved so as to approach or separate) with respect to the lower side variable height section 48.

Left and right arch members 58 extend between the upper side variable height section 46 and the lower side variable height section 48. The left and right arch members 58 are, for example, configured from a resilient metal or resin plate formed in strip shape with a length direction aligned with the height direction, and are each curved in a circular arc shape convex toward the front when viewed along the left-right direction. When the upper side variable height section 46 approaches the lower side variable height section 48 due to rotation of the motor 54, the curvature of the curve of the left and right arch members 58 becomes tighter, and height direction intermediate portions of the arch members 58 project forward. Moreover, when the upper side variable height section 46 separates from the lower side variable height section 48 due to rotation of the motor 54, the curvature of the curve of the left and right arch members 58 becomes less pronounced, and the height direction intermediate portions of the left and right arch members 58 retreat rearward.

A lumbar support plate 60 is arranged at a front side of the left and right arch members 58. The lumbar support plate 60 is, for example, configured by injection molded resin, and is formed in a substantially plate shape having a length direction aligned with the height direction and a thickness direction aligned with the front-rear direction. An upper end portion of the lumbar support plate 60 is coupled to the upper side base 44 through an attachment wire 80, described later. The lumbar support plate 60 contacts a back face of the seatback pad 24. The lumbar support plate 60 is displaced in the front-rear direction by changes to the curvature of the curve of the left and right arch members 58 configured as described above. This thereby results in a configuration such that a strength of support to the lumbar region of the seated person can be adjusted.

An attachment bracket 62 is arranged inside the seatback 14 above the lumbar support mechanism 42. The attachment bracket 62 is, for example, configured by injection molded resin in a plate shape, and is formed in a substantially plate shape having a length direction aligned with the left-right direction and a thickness direction aligned with the front-rear direction. The attachment bracket 62 is arranged at the front side with respect to the left and right lumbar wires 36, and is supported by the left and right lumbar wires 36 through the attachment wire 80 and the upper side base 44, as described later.

As illustrated in FIG. 2 to FIG. 5, an air blower 66 is attached to a left-right direction central portion of the attachment bracket 62. The air blower 66 is disposed at the rear side with respect to the attachment bracket 62. The air blower 66 is, for example, a centrifugal air blower, and includes a non-illustrated centrifugal fan having an axial direction aligned with the front-rear direction, and a case 68 housing the centrifugal fan. The case 68 is, for example, configured by injection molded resin, and is formed with a square shape when viewed from the front-rear direction, and thin in the front-rear direction.

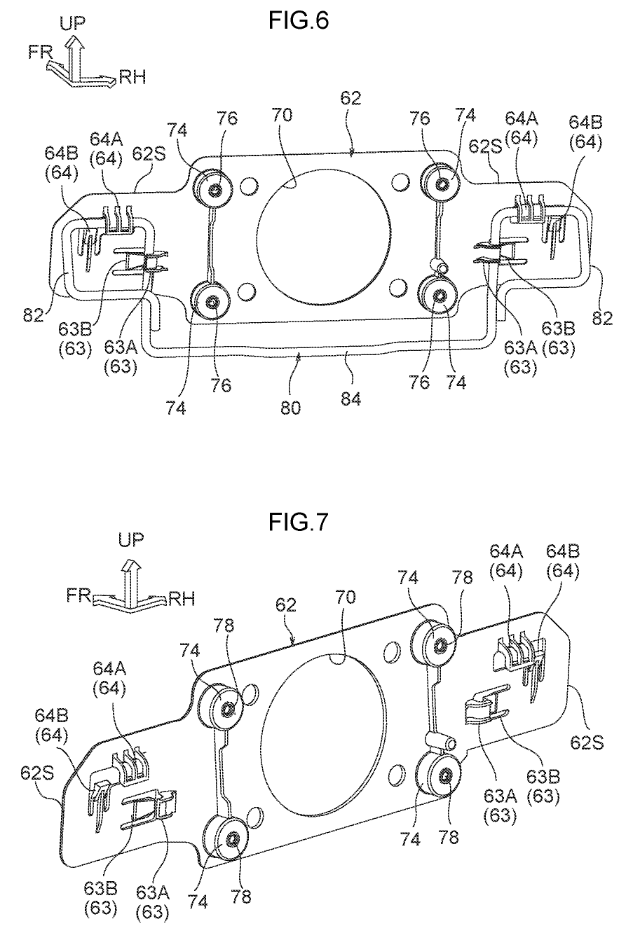

As illustrated in FIG. 6 and FIG. 7, a circular through hole 70 is formed in a left-right direction central portion of the attachment bracket 62. An air intake port 68A provided to the case 68 of the air blower 66 is inserted into the circular through hole 70. The air intake port 68A is formed in a circular cylindrical shape having an axial direction aligned with the front-rear direction, and is arranged contacting the back face of the seatback pad 24. Although not illustrated in the drawings, plural air intake holes are formed in the seatback pad 24 at locations facing toward the air intake port 68A.

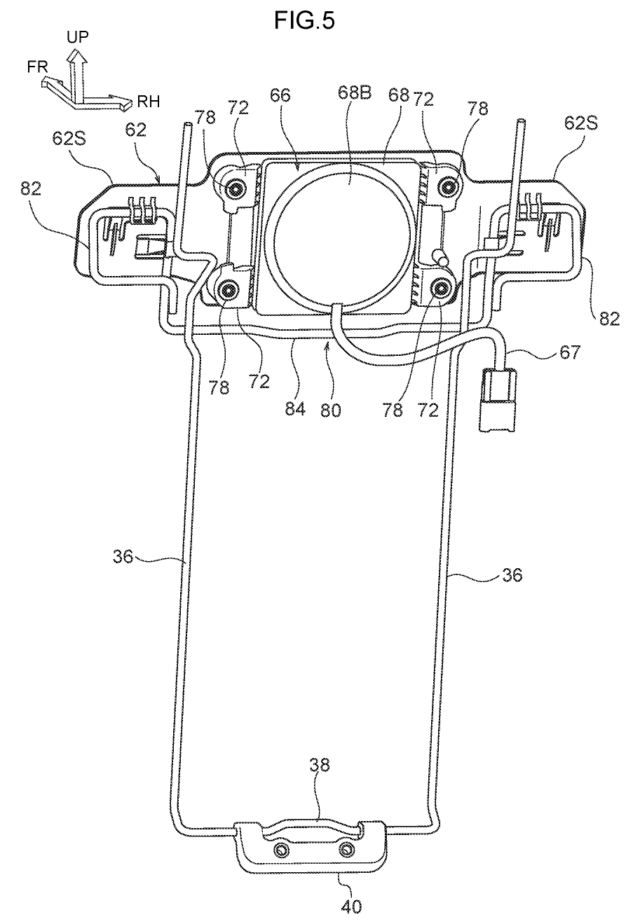

As illustrated in FIG. 3 and FIG. 5, a bottomed circular cylindrical shaped fan housing section 68B is provided to a rear portion of the case 68 with its axial direction aligned with the front-rear direction. The centrifugal fan is housed inside the fan housing section 68B. Plural non-illustrated air discharge ports are formed to a peripheral wall portion of the fan housing section 68B.

A non-illustrated motor for rotating the centrifugal fan is provided inside the case 68. This results in a configuration such that, when the centrifugal fan is rotated by this motor, air at a front face side (namely, the seated person side) of the seatback 14 is suctioned into the air intake port 68A through the plural air intake holes described above, and is then air is discharged through the plural air discharge holes described above. Note that reference numeral 67 in FIG. 3 to FIG. 5 indicates a harness for supplying power to the above motors.

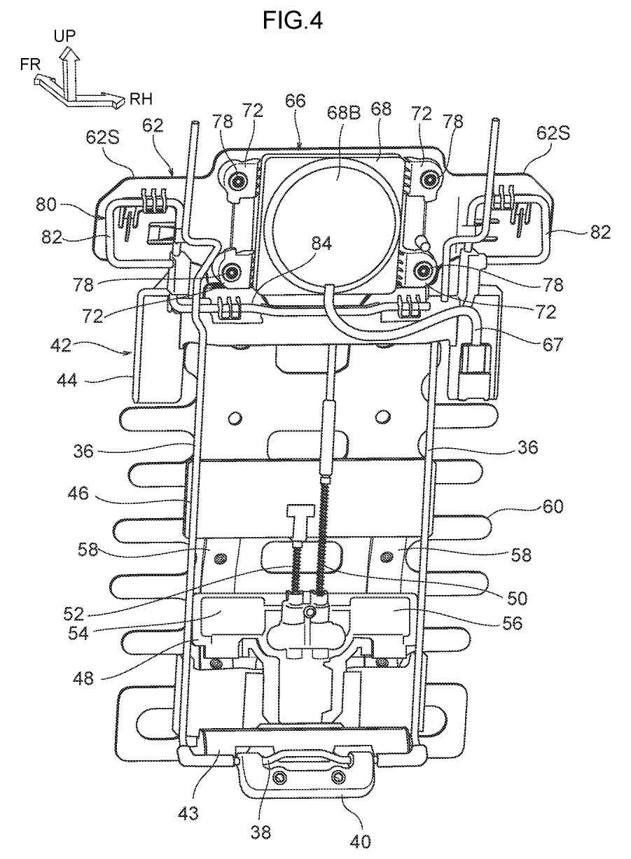

As illustrated in FIG. 4 and FIG. 5, two upper and lower fastening tabs 72 are provided to each of a left end portion and a right end portion of the case 68. Each of the fastening tabs 72 is formed in a plate shape having a plate thickness direction aligned with the front-rear direction, and a circular screw hole (omitted in the drawings) is formed to a central portion of the fastening tab 72. Four fastening seats 74 are formed to the attachment bracket 62 corresponding to the four fastening tabs 72 as illustrated in FIG. 6 and FIG. 7. The fastening seats 74 are each formed in a substantially cylindrical shape having an axial direction arranged along the front-rear direction.

Nuts 76 are embedded in the respective fastening seats 74 by, for example, insert molding. The fastening tabs 72 are superimposed on the respective fastening seats 74 from the rear side, and screws 78 (see FIG. 4 and FIG. 5) inserted into the screw holes in the fastening tabs 72 are threaded into the nuts 76 in the respective fastening seats 74. The air blower 66 is thereby attached to the rear face of the attachment bracket 62.

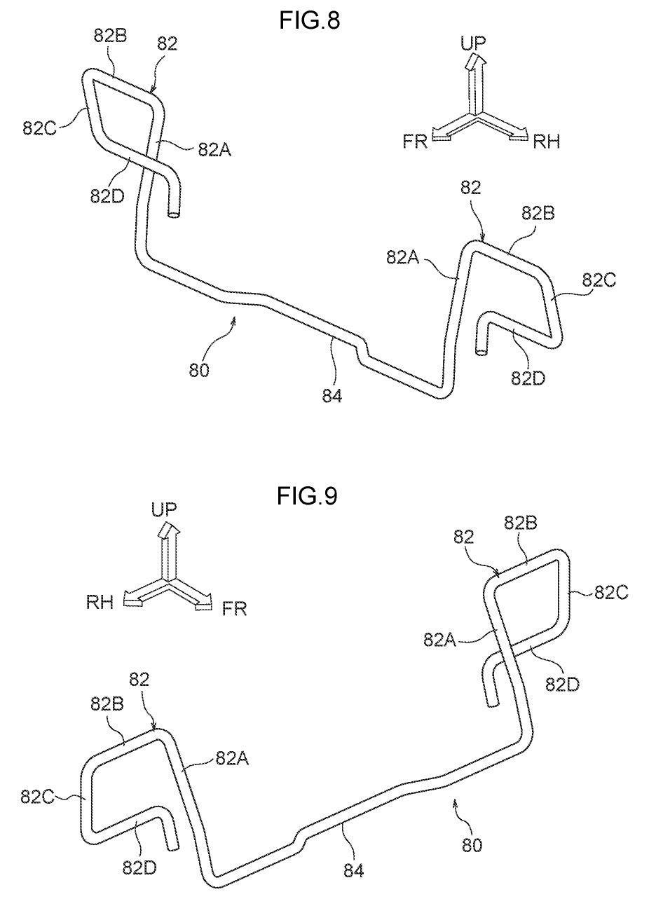

As illustrated in FIG. 3 and FIG. 4, the attachment bracket 62 is coupled to the upper side base 44 of the lumbar support mechanism 42 through the attachment wire 80. As illustrated in FIG. 8 and FIG. 9, the attachment wire 80 is a single body made by performing bend processing on a metal wire material and includes left and right attachment sections 82 and a coupling portion 84 coupling the left and right attachment sections 82 together in the left-right direction. The attachment wire 80 is integrally molded together with the upper side base 44.

The coupling portion 84 extends in the left-right direction, and a large part of the coupling portion 84 is embedded in the upper side base 44. Portions at the left and right sides of the coupling portion 84 are exposed from the upper side base 44, with an upper end portion of the lumbar support plate 60 anchored to these exposed portions. The left and right attachment sections 82 are integrally connected to the left and right end portions of the coupling portion 84 and are bent upward.

The left and right attachment sections 82 are arranged exposed at the upper side of the upper side base 44. Each of the attachment sections 82 includes a first vertical extension portion 82A that extends from an upper end portion of the upper side base 44 (namely, an upper end portion of the lumbar support mechanism 42) toward the seat upper side, a first horizontal extension portion 82B that extends from an upper end of the first vertical extension portion 82A toward the vehicle left-right direction outer side, a second vertical extension portion 82C that extends downward from a left-right direction outer side end portion of the first horizontal extension portion 82B, and a second horizontal extension portion 82D that extends from a lower end of the second vertical extension portion 82C toward the left-right direction inner side and is connected to an upper end portion of the upper side base 44.

The first vertical extension portion 82A is inclined in a direction slightly rearward on progression upward, and the second vertical extension portion 82C is inclined in a direction slightly rearward on progression downward. The left-right direction inner side end portions of the second horizontal extension portion 82D are arranged separated to the rear side with respect to the lower end portion of the first vertical extension portion 82A, and are bent downward. This bend portion of the second horizontal extension portion 82D is embedded inside the upper side base 44.

As illustrated in FIG. 6, first anchor claws 63 anchored to the first vertical extension portion 82A of the left and right attachment sections 82, and second anchor claws 64 anchored to the first horizontal extension portion 82B of the left and right attachment sections 82, are provided to left and right side portions 62S of the attachment bracket 62. The attachment bracket 62 is thereby attached to the attachment wire 80. The attachment wire 80, together with the left and right lumbar wires 36, the lumbar support mechanism 42, the attachment bracket 62, and the air blower 66, configure a “seatback air blower attachment structure” of the present disclosure.

The first anchor claws 63 include an inside anchor portion 63A engaged with the first vertical extension portion 82A from the left-right direction inner side, and an outside anchor portion 63B engaged with the first vertical extension portion 82A from the left-right direction outer side, and these clamp the first vertical extension portions 82A in the left-right direction. The second anchor claws 64 include an upper anchor portion 64A engaged with the first horizontal extension portion 82B from the upper side, and a lower anchor portion 64B engaged with the first horizontal extension portion 82B from the lower side, and these clamp the first horizontal extension portion 82B in the height direction. A configuration is accordingly achieved in which, for example, the outside anchor portion 63B resiliently deforms and then resiliently returns when the first anchor claws 63 are being anchored to the first vertical extension portion 82A and, for example, the upper anchor portion 64A resiliently deforms and then resiliently returns when the second anchor claws 64 are being anchored to the first horizontal extension portion 82B.

In the vehicle seat 10 configured as described above, the back of a seated person seated on the seat cushion 12 is supported by the seatback 14. The left and right lumbar wires 36 extend between the upper section and the lower section of the seatback frame 22, and the lumbar support mechanism 42 is attached to the left and right lumbar wires 36. The attachment bracket 62 is arranged at the upper side with respect to the lumbar support mechanism 42, and the air blower 66 is attached to a rear-side face of the attachment bracket 62.

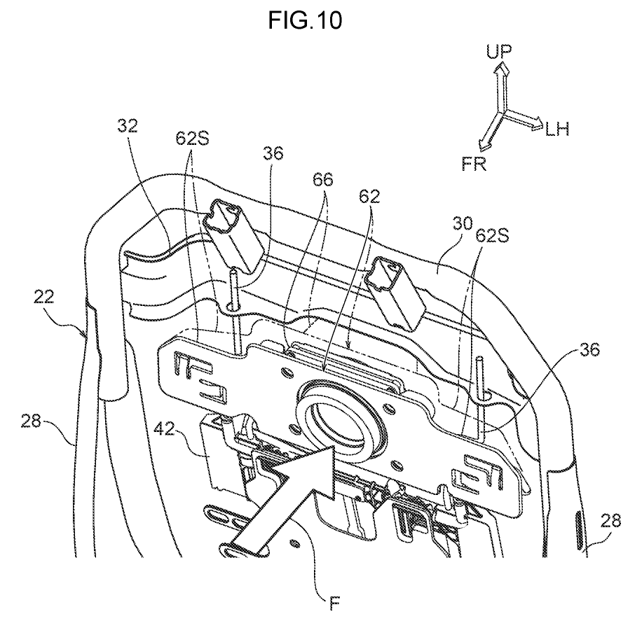

The attachment wire 80 including the left and right attachment sections 82 extend from upper end portions of the lumbar support mechanism 42, and the left and right side portions 62S of the attachment bracket 62 are attached to the left and right attachment sections 82. Load from the back of a seated person is imparted from the front side to the attachment bracket 62 at a time of a vehicle rear-end collision (see arrow F of FIG. 10). Due to the left and right attachment sections 82 of the attachment wire 80 deforming, the attachment bracket 62 and the air blower 66 are displaced rearward, as illustrated by the double-dash broken line in FIG. 10. As a result thereof, the back of the seated person is readily able to sink into the seatback 14, bringing forward the timing at which the head of the seated person is supported by the headrest 16. This thereby facilitates the prevention of whiplash injury to the seated person.

Moreover, in the present exemplary embodiment, the first vertical extension portions 82A provided to the left and right attachment sections 82 of the attachment wire 80 extend upward from the upper side base 44 of the lumbar support mechanism 42. The first horizontal extension portions 82B extends toward the left-right direction outer side from the upper ends of the first vertical extension portions 82A, and the second vertical extension portions 82C extend downward from the left-right direction outer side end portions of the first horizontal extension portions 82B. The second horizontal extension portions 82D extend toward the left-right direction inner side from the lower end of the second vertical extension portions 82C, and the second horizontal extension portions 82D are connected to the upper side base 44.

The first anchor claws 63 provided to the left and right side portions 62S of the attachment bracket 62 are anchored to the first vertical extension portions 82A of the left and right attachment sections 82, and the second anchor claws 64 provided to the left and right side portions 62S of the attachment bracket 62 are anchored to the first horizontal extension portions 82B of the left and right attachment sections 82. The attachment bracket 62 is permitted to flex (deform) rearward between the first vertical extension portions 82A of the left and right attachment sections 82 in a case in which a load from the front side is imparted to the attachment bracket 62. This accordingly further facilitates the back of the seated person sinking into the seatback 14.

Moreover, the present exemplary embodiment is configured such that, the attachment bracket 62 and the left and right attachment sections 82 of the attachment wire 80 are resiliently deformed by load from the back of the seated person at a time of normal usage. This thereby enables good seating comfort to be achieved for the seated person.

Moreover, the present exemplary embodiment is configured such that the attachment bracket 62 and the left and right attachment sections 82 of the attachment wire 80 plastically deform rearward under a load from the back of the seated person at a time of a vehicle rear-end collision. This thereby enables energy of the seated person to be absorbed, enabling the seated person whose back has sunk into the seatback to be suppressed from rebounding forward.

Note that although the present exemplary embodiment described above is a configuration in which the left and right attachment sections 82 of the attachment wire 80 are integrally coupled together by the coupling portion 84, there is no limitation thereto, and a configuration may be adopted in which the left and right attachment sections 82 of the attachment wire 80 are divided left and right.

In addition thereto, various other modifications may be implemented for the present disclosure within a range not departing from the spirit thereof. Moreover, obviously the scope of rights of the present disclosure is not limited to the above exemplary embodiment.

What is claimed is:

1. A seatback air blower attachment structure, comprising:
left and right lumbar wires respectively extending between an upper section and a lower section of a seatback frame of a vehicle seat;
a lumbar support mechanism attached to the left and right lumbar wires;
an attachment bracket arranged at a seat upper side with respect to the lumbar support mechanism;
an air blower attached to a seat rear-side face of the attachment bracket; and
an attachment wire including left and right attachment sections that extend from an upper end portion of the lumbar support mechanism with left and right side portions of the attachment bracket attached thereto, the left and right attachment sections deforming in a case in which a load from a seat front side is imparted to the attachment bracket.

2. The seatback air blower attachment structure of claim 1, wherein:
the attachment sections each include:
a first vertical extension portion extending from an upper end portion of the lumbar support mechanism toward the seat upper side,
a first horizontal extension portion extending from an upper end of the first vertical extension portion toward a seat left-right direction outer side,
a second vertical extension portion extending from a seat left-right direction outer side end portion of the first horizontal extension portion toward a seat lower side, and
a second horizontal extension portion that extends from a lower end of the second vertical extension portion toward a seat left-right direction inner side and that is connected to an upper end portion of the lumbar support mechanism, and
the side portions each include:
a first anchor claw anchored to the first vertical extension portion, and
a second anchor claw anchored to the first horizontal extension portion.

3. The seatback air blower attachment structure of claim 2, wherein the attachment bracket resiliently deforms under a load from the back of a seated person at a time of normal usage.

4. The seatback air blower attachment structure of claim 2, wherein the attachment bracket plastically deforms under a load from the back of a seated person at a time of a vehicle rear-end collision.

5. The seatback air blower attachment structure of claim 1, wherein the left and right attachment sections resiliently deform under a load from the back of a seated person at a time of normal usage.

6. The seatback air blower attachment structure of claim 1, wherein the left and right attachment sections plastically deform under a load from the back of a seated person at a time of a vehicle rear-end collision.

7. A vehicle seat, comprising:
a seat cushion at which a seated person sits; and
a seatback configured to support the back of the seated person,
wherein the seatback includes the seatback air blower attachment structure of claim 1.
